(19) United States
(12) Patent Application Publication
(10) Pub. No.: US 2015/0348030 A1
(43) Pub. Date: Dec. 3, 2015

(54) SYSTEM AND METHOD FOR ELECTRONIC PAYMENT

(71) Applicants: MasterCard International Incorporated, Purchase, NY (US); Optal Limited, London (GB)

(72) Inventors: Alain CAUWENBERGHS, Wolvertem (BE); Robert BISHOP, London (GB)

(73) Assignees: OPTAL LIMITED, London (GB); MASTERCARD INTERNATIONAL INCORPORATED, Purchase, NY (US)

(21) Appl. No.: 14/708,698

(22) Filed: May 11, 2015

(30) Foreign Application Priority Data
May 9, 2014 (GB) 1408241.6

(51) Int. Cl. G06Q 20/40

(52) U.S. Cl. CPC G06Q 20/40

(57) ABSTRACT

A system for processing a payment transaction, comprises a first entity configured to initiate a payment transaction with a merchant, a second entity configured to issue an account number in respect of the payment transaction, and a transaction processor configured to route the payment transaction between the merchant and the second entity in order to obtain authorization for the payment transaction from the second entity. The system is provided with an escrow account facility configured to hold an advanced fund associated with the payment transaction, the escrow facility being controlled by the transaction processor. The invention is also expressed in a method for processing a payment transaction.

### TECHNICAL FIELD

The invention relates in general to electronic payment transactions carried out within the context of a financial authorization, clearing and settlement system.

### BACKGROUND

E-commerce is now well established and paying for goods and services online has become fully adopted by consumers or ‘buyers’ in general. Typically, a buyer will have a prepaid card, debit or credit card, collectively termed ‘payment card’, with which to initiate an online financial transaction with a merchant in order to purchase goods or services (hereinafter, simply ‘goods’).

To commence a transaction, the first step is that payment data is collected from the buyer, be it a private individual or a business, and is input into a payment system. This data collection phase could be handled by a call centre operative or, more commonly, the data could be entered directly into a webpage by the buyer.

The merchant then constructs a payment transaction and communicates with an associated merchant's bank or ‘acquirer’ over a communications network, the web for example, in order to obtain an authorization for the payment that the buyer wishes to make. The acquirer then communicates the transaction to a transaction processor which carries out a cardholder authentication process. In this process, after the transaction processor has carried out appropriate validation and security checks on the card, the transaction processor communicates the transaction to the cardholder's bank, also referred to as the ‘issuer’ of the card in question, which then performs the fraudulent activity checks and the necessary credit worthiness checks to ensure that the account balance of the cardholder is sufficient to cover the payment amount. Following these checks, the issuer communicates back down the chain an indication that the requested payment transaction has been authorised and so the merchant is able to conclude the sale with the buyer.

Sometime after the authorization process has been completed, ‘clearing and settlement’ is performed in which the authorised transaction is sent within a batch process during which the merchant sends all its stored authorised transactions to the payment processor which arranges to debit the relevant issuer for payment and then credits the relevant acquirer. In essence, therefore, the issuer pays the acquirer for the amount of the transaction. Finally, once the acquirer has been credited with the transaction amount, the acquirer pays the merchant who receives an amount totalling the transaction amount less associated fees that the merchant agrees to pay the acquirer for handling the transactions.

Although businesses and private individuals have grown accustomed to carrying out financial payment transactions online, electronic payments are susceptible to fraud and abuse.

Techniques to mitigate fraud in an online financial transaction environment have been developed. One such approach focuses on preventing the account number of the cardholder being transmitted over a network, essentially making the cardholder's physical account invisible to interlopers. Here, a temporary account number is created that is used in a transaction instead of the primary account number (PAN) of the cardholder's credit or debit card. The temporary account number may be time-limited such that it remains valid for a certain period of time, anything from a few minutes to several days, weeks or months, or merchant-limited such that the account number may also be used with a specific merchant business. Alternatively, or in addition, the temporary account number may be valid for a predetermined number of transactions. For example, it may be valid only for a single use, or it may be valid for multiple uses. The use of temporary account numbers is known in the art, and they may also be known as ‘virtual account numbers’ (VANs), ‘controlled payment numbers’ or ‘secure online account numbers’ to name a few examples. Virtual account numbers in essence act as a ‘front’ for an existing payment card account number, and are generated as a buyer shops online to improve security of the transaction since the virtual account number is limited in its use. Typically, a prerequisite of generating a virtual account number is pre-payment for the amount of the transaction, which further militates against fraud because the account is only valid for the exact amount of the transaction and no further credit line is extended to the user of the account.

It is within the context of electronic payments using virtual account numbers that the present invention has been devised.

### SUMMARY OF THE INVENTION

In a first aspect, the invention provides a system for processing a payment transaction, comprising: a first entity configured to initiate a payment transaction with a merchant, a second entity configured to issue an account number in respect of the payment transaction; and a transaction processor configured to route the payment transaction between the merchant and the second entity in order to obtain authorization for the payment transaction from the second entity. The system further includes an escrow account configured to hold an advanced fund associated with the payment transaction, the escrow account being controlled by the transaction processor.

A benefit of the system is that since the transaction processor controls the advanced fund through the escrow account, the transaction processor is able to limit the operational risk to which it is exposed during the course of handling payment transactions between the first entity that initiates the payment transaction, which may be considered to be a ‘customer’ in the system, and the second entity that issues an account number in respect of the payment transaction. This reduction in operational risk benefits buyers since these types of secure payment processes are able to be rolled-out to a wider spread of buyers in an online environment.

The escrow account may comprise a first subaccount and a second subaccount, wherein the advanced fund may be deposited into the first subaccount as an initial step. Subsequently, the advanced fund may be transferred from the first subaccount to the second subaccount either in accordance with a predetermined schedule or when initiated. One option is that the advanced fund is transferred from the first subaccount to the second subaccount prior to the first entity initiating the payment transaction at the merchant.

In one embodiment, the advanced fund is deposited into the escrow arrangement by a customer associated with the first entity, although the first entity may also deposit the advance fund on behalf of the customer.

The first entity may be configured to communicate with the second entity to request issuance of the account number. In order to ensure that appropriate funding is in place, the advanced fund may be deposited into the escrow arrangement before the first entity communicates with the second entity to request issuance of the account number.

Although the account number may be a primary account number, in a preferred embodiment the account number issued by the second entity is a limited-use account number. The limited-use account number may be of the type that remains valid for a predetermined time period or, alternatively, may be of the type that remains valid for a predetermined number of payment transactions.

In a second aspect, the invention resides in a method for processing a payment transaction, comprising: receiving a payment transaction at a transaction processor, the payment transaction being initiated by a first entity in relation to a merchant, wherein the payment transaction is associated with an account number; routing the payment transaction between the merchant and a second entity in order to obtain authorization for the payment transaction from the second entity; receiving an advanced fund associated with the payment transaction into an escrow arrangement controlled by the transaction processor.

Preferred and/or optional features of the first aspect of the invention may be combined as appropriate with the second aspect of the invention.

In one embodiment, the transaction processor controls the transfer of the advanced fund from the first subaccount to the second subaccount in accordance with a predetermined schedule. This provides the benefit that the transfer of advanced funds is automatic and improves the efficiency of the management of the advanced funds in the escrow arrangement.

The transaction processor may control the transfer of the advanced fund from the first subaccount to the second subaccount prior to the first entity initiating the payment transaction at the merchant.

The invention also resides in a computer system adapted to carry out the method as described above.

### BRIEF DESCRIPTION OF THE DRAWINGS

In order that the invention may be better understood, reference will now be made by way of example to the accompanying drawings in which:

FIG. 1 is a system diagram of a payment transaction environment which also illustrates a process flow as a payment transaction is carried out between entities in the environment; and

FIG. 2 is a is a system diagram of a payment transaction environment similar to that in FIG. 1 but which illustrates an embodiment of the invention.

### DETAILED DESCRIPTION OF THE INVENTION

In the context of electronic payment transactions, the invention makes more efficient the transactional processes that are carried out between multiple entities involved with a transaction. In particular the invention preferably involves the use of ‘limited-use’, ‘controlled payment numbers’ or ‘virtual account numbers’ in the payment of goods and services as opposed to primary account numbers in order to provide a security benefit to buyers in the system.

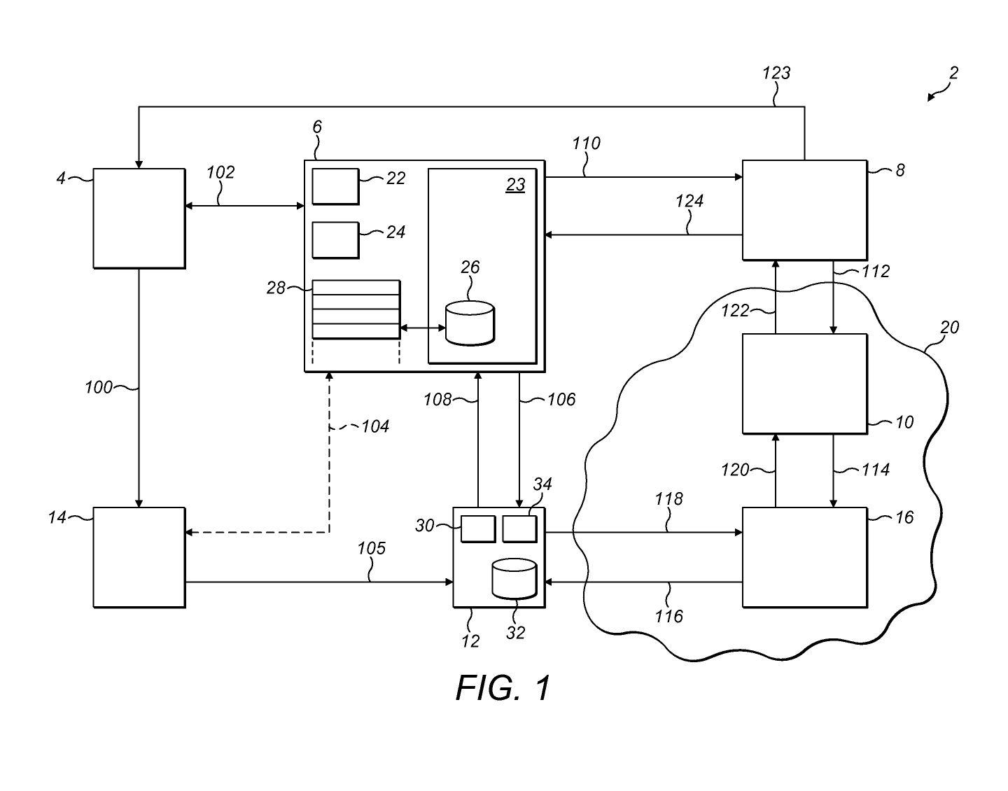

To put the invention into context, a known system will now be described with reference to FIG. 1. FIG. 1 illustrates in schematic form an electronic commerce or payment system 2 involving a number of entities, and it also shows the flow of data between the entities. The data flows between the various entities may be by way of a dedicated data link, for example a dial-up connection or by way of a general data communication network which for present purposes can be considered to be embodied by the Internet. The skilled person will, however, appreciate that other data communications networks could be used.

The electronic commerce system 2 includes several participants. In overview, these participants are: an end customer 4, an account intermediary 6, a merchant 8, a merchant acquirer bank 10, an issuing bank 12, a deposit bank 14 and a transaction processor 16. Each of these participants is equipped with a suitable computing system that facilitates e-commerce transactions. As such, it should be appreciated that the terms ‘issuing bank’, ‘acquirer bank’ and the like are intended to mean computer implemented systems or platforms that represent those establishments and that are able to communicate data and instructions between one another, as appropriate, using established protocols.

Although labelled as ‘banks’, the merchant acquirer bank 10, the issuing bank 12, and the deposit bank 14 may also represent other forms of financial institutions such as credit/debit card companies, card sponsors or other third party card issuers under contract with suitable financial institutions. Furthermore, it should be noted that other institutions may be involved at various stages of the financial transaction process, such as intermediate settlement entities, but these are not shown here for clarity.

Turning initially to a first region of the system 2 in more detail, the merchant 8 and the issuing bank 12, hereinafter ‘issuer’, are connected to each other via further network 20. The further network 20, which shall now be referred to as the ‘payment network’ 20, represents one or more existing proprietary networks that are compatible with and facilitate transactions relating to payment cards such as debit/credit, charge cards or any other type of card that may be issued by a regulated financial institution. Examples of such a payment network would be the MasterCard Worldwide Network provided by MasterCard, and also VisaNet as provided by Visa, and such transactions may be conducted in accordance with the EMV (EuroPay MasterCard Visa) standard as is known in the art. MasterCard, Visa, VisaNet, and EMV are hereby acknowledged as trademarks.

Between the merchant 8 and the issuing bank 12 operates an established electronics payments process as is well known in the art. The transaction processor 16 performs a vital function in processing, or switching, transactions in order to connect together merchants, financial institutions and card/account holders to facilitate fast, reliable and secure payments through three stages generally referred to as authorization, clearing, and settlement, which are known in the art but which will now briefly be described in general terms for completeness. Note that in the UK context the service provided by the transaction processor 16 may be by a payment network infrastructure brand such as Visa or MasterCard, although the skilled person would be aware of other such organisations. Accordingly, it will be appreciated that the transaction processor 16 is a suitable computing platform including a computing module, having a processor, and a memory device suitably programmed for its role in the transaction process.

### Authorization

On initiation of a transaction, the merchant constructs an authorization request including payment information and sends the authorization request to its financial institution, the acquirer, for authentication. The acquirer authenticates the identity of the customer and forwards the authorization request to the transaction processor (for example MasterCard or Visa, depending on the payment card branding) for account validation and routing. At this point, the transaction processor may also perform additional security checks such as risk profiling and fraudulent activity detection. From there, the transaction processor 16 routes the authorization request to the issuer 12, for verification. Once the issuer 12 verifies the availability of funds for the amount of the transaction, and ring fences them, it sends the verification back to the transaction processor 16. In turn, the transaction processor routes the verification to the acquirer 10 who, in turn, notifies the merchant 8 that the purchase has been approved.

### Clearing

Following completion of the transaction between the customer and the merchant, the transaction undergoes ‘clearing’. Typically within a day of authorization, the merchant batch-transmits all of their sales transactions associated with the organisation represented by the transaction processor to the acquirer. The acquirer batches and sends the payment information to the transaction processor which then validates the accuracy of the transaction information submitted by the acquirer in order to reconcile funds between issuers and acquirers. This reconciliation process balances funds between payment parties on a regular basis.

### Settlement

Typically within two days of authorization, and after transactions have been cleared, the transaction processor calculates the debited and credited amounts between issuers and acquirers, also termed the ‘net settlement position’. During this process, the issuer is informed of the funds to be debited from cardholder accounts to settle transactions and the acquirer is informed of the funds to be credited to merchant accounts net of fees levied by the transaction processor.

Having described in the established payment network 20 in general terms, focus will now turn on the remainder of the system 2.

Although the merchant 8 may handle transactions from a variety of customers, in this particular system the customer is represented by the account intermediary 6. The function of the account intermediary 6 is to act on behalf of the end customer 4 in order to purchase goods/services from the merchant 8. To put the system in context, the end customer 4 may be a booking agent of a travel company that books holiday packages, car rental agreements, flights and so on, on behalf of its clients (not shown, but their presence is implied). The merchant 8 may be represented by an airline in this example.

A primary role for the account intermediary 6 is to handle purchasing instructions from the end customer 4 that generate requests for a virtual account numbers (VANs) and to liaise with the issuer 12 for the generation of the VANs. As has been discussed above, VANs are preferred due to benefits conferred on the end customer 4 for security and efficient accounting practices amongst other things. Here, the VANs are issued in respect of ‘prepaid’ or ‘advanced’ funds that are credited to the deposit bank 14 from the end customer 4 and that are linked to the transaction that will be performed.

The account intermediary 6 is implemented on a computer and comprises, in overview, a processor 22 with associated operating memory in the form of ROM/RAM 23, an I/O system 24 for handling communication data between the end customer 4, the merchant 8 and the issuer 12, a customer account database 26 and an account manager 28.

The issuer 12 is also implemented on a computer and includes an account manager 30, an account data base 32 and a VAN generator 34. The account manager 30 liaises with and responds to requests from the account intermediary 6 to generate a VAN, as will now be described.

The process begins with the end customer 4, in this case a travel agent, deciding to make and pay for a booking for a product, for example a flight with the airline represented by the merchant 8. Usually the booking decision will be in response to a client of the end customer 4 showing interest in the product and requesting that a booking be made, either as a specific booking or as part of a package of travel-related products including hotel stays and car rental agreements.

Having established that a booking needs to be made, the end customer 4 deposits the necessary advanced fund with the deposit bank 14, as shown at arrow 100, so that funding for the transaction is in place for later interrogation by the issuer 12, as will become apparent. The end customer 4 then contacts the account intermediary 6 in order to construct a purchase instruction and request a VAN. It will be appreciated that the advanced fund may be provided by the client of the end customer 4 prior to the booking, or that the end customer 4 may invoice the client only after the booking has been made.

At this point the account intermediary 6 already has an established relationship with the end customer 4 since the end customer 4 will have already been through a registration procedure with the account intermediary 6 that, amongst other things, registers the deposit bank 14 associated with the end customer 4 with the account intermediary 6.

Upon receiving the purchase instruction and the VAN request from the end customer 4, as shown at arrow 102, the account intermediary 6 checks the funding position of the end customer 4 at the deposit bank 14, as is illustrated by the dashed arrow 104. In practice, funding position check 104 will be represented by a constant flow of information between the account intermediary 6 and the deposit bank 14. Note that the account held at the deposit bank 14 is an account in the name of the account intermediary 6 but which is associated with the end customer 4 and established at the registration process between the end customer 4 and the account intermediary 6. However, in a preferred embodiment, the account held at the deposit bank 14 is a single account per country into which funds are deposited by the end customer 4. The funds can carry suitable identifiers to enable them to be cross referenced to the end customer 4.

Once the availability of the advanced fund has been established, the account intermediary 6 contacts the issuer 12, as shown by arrow 106, in order to secure a new VAN and instructs the advanced fund to be transferred from the deposit bank 14 to the issuer 12 for the amount of the purchase instruction. The transfer of the advanced fund is shown by arrow 105.

In response to receiving the advanced fund from the deposit bank 14 and the VAN request from the account intermediary 6, the account manager 30 at the issuer 12 logs the VAN request in the account database 32 and associates the VAN request with the advanced fund. Then, the account manager 30 accesses the VAN generator 34 which generates a suitable VAN that is acceptable by the transaction processor 16. Preferably an expiry date for the VAN is also generated to ensure that the VAN is suitably limited in time. The VAN and the expiry date can be considered collectively to be VAN data. As is known, a virtual account number has the format of a sixteen digit number in accordance with the ISO7816 standard for electronic transactions, although it is not necessarily linked to a physical card.

Following the generation of the VAN data, the VAN data communicated back from the issuer 12 to the account intermediary 6 at step 108 and is linked to the payment instructions received from the end customer 4 that is stored in the customer account database 26.

Note that the issuer 12 will not issue VAN data if insufficient funds are stored at the deposit bank 14.

The account intermediary 6 then processes the payment instruction by contacting the merchant 8 with a procurement request at step 110, including payment information and VAN information. In this system, since the merchant 8 is an airline, the procurement request from the account intermediary 6 may be transmitted over a Global Distribution System (GDS) that is known in the travel industry as a network that facilitates transaction between vendors and booking agents in order to provision travel-related goods and services in the airline, hotel, car rental and activity industries. Examples of known GDSs are Amadeus, Galileo and Worldspan, all of which are acknowledged as trademarks of their respective institutions. However, It should be appreciated the process need not be facilitated by a GDS, and that the account intermediary 6 may also communicate with the merchant directly or via other alternative systems. In other embodiments, the end customer 4, in this case a travel agent, may instead receive the VAN data from the account intermediary 6 and contact the merchant 8 directly, or via the GDS.

From this point, the interaction between the account intermediary 6 and the merchant 8 proceeds in the same way as a known authorization process, as described in overview above.

In more detail, once the account intermediary 6 has contacted the merchant 8 with the procurement request, indicated by arrow 110, the merchant 8 then constructs a payment transaction and communicates with the acquirer 10 via the payment network 20, as indicated by arrow 112, in order to obtain an authorization for the transaction that the account intermediary 6 wishes to make on behalf of the end customer 4. In response, the acquirer 10 authenticates the identity of the account intermediary 6 and communicates with the transaction processor 16, as illustrated by arrow 114, for validation of the request and so the request can be routed to the relevant issuer, in this case the issuer 12 that generated the VAN.

A principal role of the transaction processor 16 is to route the payment transaction to the issuer 12, but it may also carry out suitable security checks and risk profiling, as is expected of such an institution that administers the payment network 20 and assures guaranteed processing. Following such checks the transaction processor 16 communicates the transaction to the issuer 12 which generated the VAN data as illustrated as arrow 116. Since in this system 2 the transaction is subject to advanced funding, the issuer 12 confirms that it has the funds to service the transaction and communicates a response to the transaction processor 16, as illustrated at arrow 118, providing authorization of the transaction.

Assuming that authorization has been given, at this point the transaction will include the authorization from the issuer 12, and the transaction processor 16 communicates back to the acquirer 10 as illustrated by arrow 120. Having received the authorised transaction data from the issuer 12, the acquirer 10 then communicates the transaction data to the merchant 8, as illustrated at arrow 122. At this point, the merchant 8 issues the purchased good directly to the end customer 4 as indicated by arrow 123. In this case, the purchased goods may be a set of one or more airline tickets that may be delivered in an electronic format over the internet or by way of a suitable overland postal service for example. The merchant 8 then contacts the account intermediary 6, illustrated by arrow 124, to provide the authorization details and to indicate that the purchase instruction has been fulfilled through delivery of the goods to the end customer 4. Issuing the purchased goods directly to the end customer 4 removes the need for the account intermediary 6 to perform any routing of goods. However, it should be appreciated that this isn't essential and the purchased goods may instead be delivered to the account intermediary 6 in some circumstances, for example if the business requires that third party branding should be applied to the goods following issuance by the merchant 8 or the application of a gift-wrapping service, for example. As a further alternative, the goods may be delivered directly to the client of the end customer 4.

The electronic payment system 2 in FIG. 1 illustrates an environment where goods and services may be paid for electronically using the relative security of virtual account numbers as opposed to the more traditional primary account numbers. In order to achieve this, there needs to be numerous financial agreements in place to enable the system to perform within acceptable parameters. As an example, the issuer 12 and the account intermediary 6 must agree that the issuer 12 is willing to provide VANs on the basis of advanced funds it receives, as facilitated by the account intermediary 6 through its interaction with its end customers 4. Furthermore, the transaction processor 16 must be satisfied that the financial risk that it is exposed to during operations with the issuer 12 is at an acceptable level. To this end, the transaction processor 16 typically has financial agreements with many thousands of issuers that become ‘members’ of its network, and a part of the member agreement is to manage the risk associated with the operations of its members. To achieve this, the transaction processor 16 may have several risk management techniques at its disposal. One suitable risk management technique is to require ‘operating capital’ funds from the issuer 12 sufficient to cover the financial volume processed by the issuer 12 in a given period of time, for example for duration of one week. The operating capital requirement is typically passed on to the organisation with which the issuer has agreements which, in this case, is the account intermediary 6. The volume of business processed by the account intermediary may be significant. As will be appreciated, therefore, such levels of operating capital may present a serious drag on the business activities of the account intermediary and acts as a significant barrier to entry to general competing businesses in the market.

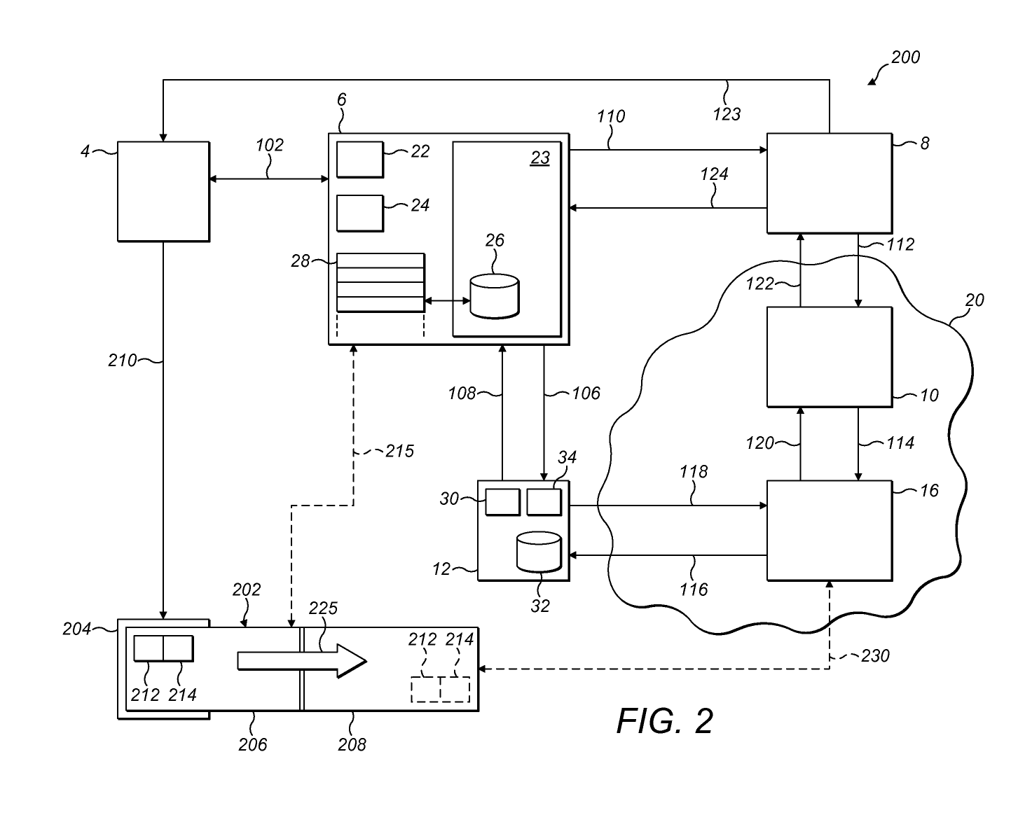

With a view to mitigating these problems, an improved electronic payments system 200 will now be described with reference to FIG. 2.

The improved electronics payment system 200 is similar to that in FIG. 1 and so the same reference numerals will be used to refer to system entities in common with the system 2 of FIG. 1 for reasons of clarity.

The electronics payment system 200 in FIG. 2 comprises broadly the same entities as in FIG. 1, namely the end customer 4, the account intermediary 6, the merchant 8, the acquirer 10, the issuer 12, and the transaction processor 16.

However, instead of the deposit bank 14 in the system of FIG. 1, the system 200 of FIG. 2 includes an escrow facility or arrangement 202 in the form of an account provided by an escrow provider 204, which may be a regulated financial institution such as a bank or an e-money licensing institution.

Although the functionality of the escrow arrangement will be described in detail later, in a broad overview the escrow arrangement 202 comprises first and second subaccounts 206, 208. The first subaccount 206 is an account that is associated with the account intermediary 6 and is held on trust by the escrow provider 204. However, the end customer 4 is able to make deposits into the first subaccount 206. The second subaccount 208 is associated with the transaction processor 16 in order that the transaction processor 16 may withdraw funds from the second subaccount 208 and is also provided on trust by the escrow provider 204.

It will be appreciated that the escrow arrangement 202 is described here as a single provider which establishes a financial association between the account intermediary 6 and the transaction processor 16 via the transactional banking partner (the escrow provider 204). Although it is generally preferred that both subaccounts 206, 208 are established by a single provider due to the resulting ease and speed by which funds may be transferred between the sub-accounts, this is not essential and the subaccounts 206,208 may alternatively be established by separate providers.

The process by which the end customer 4 initiates a payment transaction and how the transaction is handled by the account intermediary 6, the merchant 8, the acquirer 10, the issuer 12, and the transaction processor 16 is similar to the process described above with reference to FIG. 1. Thus, the end customer 4 begins the process by contacting the account intermediary 6 and identifying the merchant 8 from which the end customer 4 wishes to purchase goods for which, in response, the account intermediary 6 provides the end customer 4 with a pre-funding reference, which may be an alphanumeric string that serves as a unique identifier for the advanced fund.

Having established the goods to be purchased at the merchant 8 via the account intermediary 6, the end customer 4 deposits the advanced fund required to pay for the goods at the first subaccount 206 of the escrow arrangement 202, as shown at arrow 210, the funds being identified by the pre-funding reference provided by the account intermediary 6. Note that the advanced fund is identified within the subaccount 206 by the numeral 212 and the pre-funding reference is identified by the numeral 214.

Following this, the end customer 4 then triggers the account intermediary 6 to construct a purchase instruction and to request a VAN. As in the system 2 of FIG. 1, it will be appreciated that the end customer 4 has an existing relationship with the account intermediary 6 that has been established through a registration procedure that creates the subaccount 206 and links both the end customer 4 and the account intermediary 6 with the subaccount 206, so that the end customer 4 can deposit funding into the subaccount 206 and so the account intermediary 6 can determine the existence of the advanced fund and order a transfer of the advanced fund, as will be described. Note here that the subaccount 206 will in actual fact most likely be a single subaccount for all transactions carried out in a given country.

Once the purchase instruction has been constructed and the VAN request has been made, the account intermediary 6 checks the funding position of the first subaccount 206 as illustrated at arrow 215. Here, the account intermediary 6 checks for known value of the advanced fund 212 that is linked to the pre-funding reference 214 which the account intermediary 6 provided to the end customer 4 at the initial contact.

Once the account intermediary 6 has established the existence of the advanced fund 212, it then contacts the issuer 12, as shown by arrow 106, in order to secure a new VAN.

At this point, the system 200 differs from that described with respect to FIG. 1 since fund transfer does not take place to the issuer 12 directly but occurs indirectly via the escrow account 202. In order that the issue 12 is aware that funding is in place, upon contacting the issuer 12 to request the VAN, the account intermediary 6 also provides the issuer 12 with an indication that the advanced funds 212 are in place within the subaccount 206. This may be achieved for example by setting an appropriate flag in a VAN request message sent from the account intermediary 6 to the issuer 12.

Since the issuer 12 has determined that the purchase instruction has been funded, it is able to issue the VAN. If funding is not in place, the issuer 12 will not generate a VAN. To this end, the account manager 30 at the issuer 12 logs the VAN request in the account database 32 and accesses the VAN generator 34 which generates a suitable VAN in a predetermined format as described above and which is communicated back to the account intermediary 6 as shown at arrow 108 which links the VAN to the payment instructions stored in the customer account database 26.

At this point, and as illustrated by arrow 225, the account intermediary 6 may order the advanced fund 212 to be transferred to the second subaccount 208 which is, as explained above, provided on trust for, but under the control of, the transaction processor 16. However, an alternative option is that the advanced funds 212 are transferred from the first subaccount 206 to the second subaccount 208 automatically at a predetermined point in time, under the control of the transaction processor 16. In practice, the advanced fund 212 would just be one of several advanced funds that respective end customers of the account intermediary 6 deposit in the first subaccount 206. Therefore, automatic transfer or ‘sweeping’ of the all of the advanced funds is preferable since the account intermediary 6 is not required to order the transfer of a large number of advanced fund packages from the first to the second subaccounts 206,208. This requires lower processing load and management overhead on the part of the account intermediary 6 and the transaction processor 16 and so automatic ‘sweeping’ of funds between the subaccounts 206,208 is more efficient. Under either option, however, it will be appreciated that the advanced fund 212 is under the control of the transaction processor 16 whereas in the system 2 of FIG. 1 the advanced fund was under the control of the issuer 12 at an equivalent point in time. In the above context, it may be the case that many advanced funds reside in the first subaccount, of which only a subset of the advanced funds relate to transactions that have been completed successfully. In these circumstances, it is envisaged that in some embodiments only the advanced funds that relate to a successful transaction will be transferred or ‘swept’ between the first and second subaccounts.

Now that the account intermediary 6 has received the new VAN, it is able to process the payment instruction by contacting the merchant 8 with a procurement request at step 110 which includes payment information and VAN information, among other items. As described above, since in this system 200 the merchant 8 is an airline, the procurement request from the account intermediary 6 may be transmitted over a GDS or via a direct network connection or, alternatively, the end customer 4 may receive the VAN and may contact the merchant 8 directly, or via the GDS, to purchase the necessary goods.

A payment transaction then commences in a known manner as described above with reference to FIG. 1 in that the merchant 8 constructs a payment transaction and communicates with the acquirer 10 at step 112 via the payment network 20 in order to obtain authorization for the purchase from the issuer 12. The payment transaction is routed between the acquirer 10, the transaction processor 16 and the issuer 12 of the VAN.

In order to authorise the transaction, in this system 200 it is not necessary for the issuer 12 to determine the funding position since it has already been informed by the account intermediary 6 that the advanced funds are in place. Therefore, the issuer 12 is able to authorise the payment transaction and respond in kind to the transaction processor 16 at step 118. The payment transaction is then sent back down the chain from the transaction processor 16 to the acquirer 10 and back to the merchant 8 at steps 118, 120 and 122 respectively. As in the system 2 of FIG. 1, at this point the merchant 8 issues the purchased goods directly to the end customer 4 as indicated at step 123 and contacts the account intermediary at step 124 to provide details of the authorization for the payment transaction and to indicate that the procurement request has been fulfilled through delivery of the goods to the end customer 4.

Following completion of the authorization stage of the payment transaction, the transaction processor 16 performs a known clearing and settlement process in order to credit the acquirer and the merchant with funds in relation to the payment transaction. In this process, the transaction processor 16 extracts the advanced fund 212 from the second subaccount 208, as illustrated at arrow 230, and routes appropriate payment to the acquirer 10, less an ‘interchange fee’. The acquirer 10, in turn, passes on payment to the merchant 8, less a ‘merchant service charge’ or ‘discount fee’ as is known in the art. The transaction processor 16 also routes the ‘interchange fee’ to the issuer 12 so, in effect, the issuer 12 is paid for its services in enabling the payment transaction to take place with the end customer 4.

From the above description of the payment transaction within the system 200, it will be appreciated that the transaction processor 16 has control over the advanced fund 212 from an early stage, when it is transferred or ‘swept’ from the first sub account 206 to the second subaccount 208, to the stage where clearance and settlement of the payment transaction occurs. In effect, therefore, the transaction processor 16 is provided with collateral for the payment transaction simply by being in control of the advanced fund 212 during a significant portion of the payment transaction. This is beneficial, since the settlement risk to which the transaction processor 16 is exposed through processing the transaction is mitigated by way of access to the advanced funds so that it no longer needs to acquire working collateral directly from the issuer 12.

A further benefit is that the collateral provided by the availability of the advanced fund 212 in the second subaccount 208 is dynamic in the sense that the total funding position of the second subaccount 208 increases and decreases in accordance with the volume of transactions that are being handled by the account intermediary 6. So, this means that the collateral facility is self-regulating which avoids the need for the transaction processor 16 to check periodically on the transaction volume which could necessitate a request for increased collateral funding by the issuer 12.

A still further benefit of the system 200 is that it removes the issuer 12 from the process of handling the advanced funds. This disintermediation makes the system 200 of FIG. 2 more efficient than the system 2 of FIG. 1 since transfer of the advanced fund 212 between the first subaccount 206 and the second subaccount 208 is within the context of a single escrow arrangement 202 and can be automated.

The skilled person will appreciated that various changes may be made to the specific embodiments described above without departing from the invention as defined by the claims. For example, in the system 200 of FIG. 2 a single escrow provider is described which provides subaccounts in a predetermined currency. It will be appreciated that further escrow arrangements may be established, each of which providing subaccounts in other currencies so that the system can be used across several countries.

What is claimed is:

1. A system for processing a payment transaction, comprising:
a first entity configured to initiate a payment transaction with a merchant, a second entity configured to issue an account number in respect of the payment transaction;
a transaction processor configured to route the payment transaction between the merchant and the second entity in order to obtain authorization for the payment transaction from the second entity; and
an escrow account configured to hold an advanced fund associated with the payment transaction, the escrow facility being controlled by the transaction processor.

2. The system of claim 1, wherein the advanced fund is deposited into the escrow account by a customer associated with the first entity.

3. The system of claim 1, wherein the first entity is configured to communicate with the second entity to request issuance of the account number.

4. The system of claim 3, wherein the customer associated with the first entity deposits the advanced fund into the escrow account before the first entity communicates with the second entity to request issuance of the account number.

5. The system of claim 1, wherein the second entity is configured to determine that the advanced fund is present in the escrow account prior to issuing the account number.

6. The system of claim 1, wherein the escrow account comprises a first subaccount and a second subaccount.

7. The system of claim 6, wherein the advanced fund is deposited into the first subaccount.

8. The system of claim 7, wherein the advanced fund is transferred from the first subaccount to the second subaccount in accordance with a predetermined schedule.

9. The system of claim 7, wherein the advanced fund is transferred from the first subaccount to the second subaccount prior to the first entity initiating the payment transaction at the merchant.

10. The system of claim 6, wherein the second entity is configured to determine that the advanced fund is present in the escrow account prior to issuing the account number and
wherein the second entity checks the presence of the advanced fund in the first subaccount of the escrow arrangement.

11. The system of claim 1, wherein the account number issued by the second entity is a limited-use account number.

12. The system of claim 11, wherein the limited-use account number remains valid for a predetermined time period.

13. The system of claim 11, wherein the limited-use account number remains valid for a predetermined number of payment transactions.

14. The system of claim 1, wherein following authorization of the payment transaction obtained from the second entity, the transaction processor distributes payments relating to the payment transaction to the merchant and to the second entity net of fees levied by the transaction processor associated with the payment transaction.

15. A method for processing a payment transaction comprising:
receiving a payment transaction at a transaction processor, the payment transaction being initiated by a first entity in relation to a merchant, wherein the payment transaction is associated with an account number;
routing the payment transaction between the merchant and a second entity in order to obtain authorization for the payment transaction from the second entity; and
receiving an advanced fund associated with the payment transaction into an escrow account controlled by the transaction processor.

16. The method of claim 15, wherein the escrow account includes a first subaccount and a second subaccount, and wherein the transaction processor controls the escrow account to transfer the advanced fund from the first subaccount to the second subaccount.

17. The method of claim 16, wherein the transaction processor controls the transfer of the advanced fund from the first subaccount to the second subaccount in accordance with a predetermined schedule.

18. The method of claim 16, wherein the transaction processor controls the transfer of the advanced fund from the first subaccount to the second subaccount prior to the first entity initiating the payment transaction at the merchant.

19. The method of claim 15, wherein following authorization of the payment transaction by the second entity, the method includes distributing payments relating to the payment transaction to the merchant and to the second entity net of fees associated with the payment transaction.

20. The method of claim 15, wherein the account number is a limited-use account number.

21. The method of claim 20, wherein the limited-use account number remains valid for a predetermined time period.

22. The method of claim 20, wherein the limited-use account number remains valid for a predetermined number of payment transactions.

23. A transaction processor that processes a transaction between a merchant entity and an account issuing entity, the transaction processor comprising a computing module having a memory device and a processor, the computing module configured to:
receive a payment transaction, the payment transaction being initiated by the merchant entity, wherein the payment transaction is associated with an account number;
route an electronic payment transaction between the merchant entity and the account issuing entity in order to obtain authorization for the payment transaction from the account issuing entity;
receive an advanced fund associated with the payment transaction into an escrow account over which the transaction processor has control; and
transfer an advanced fund from the escrow account to an account associated with the merchant entity once the payment transaction has been authorised.

24. The transaction processor of claim 23, wherein the escrow account includes a first subaccount and a second subaccount, and wherein the transaction processor controls the escrow account to transfer the advanced fund from the first subaccount to the second subaccount.

25. The transaction processor of claim 24, wherein the transaction processor controls the transfer of the advanced fund from the first subaccount to the second subaccount in accordance with a predetermined schedule.

26. The transaction processor of claim 24, wherein the transaction processor controls the transfer of the advanced fund from the first subaccount to the second subaccount prior to the initiation of the payment transaction at the merchant.

27. A computer system adapted to carry out the method of claim 15.
